(19) United States
(12) Patent Application Publication
(10) Pub. No.: US 2016/0225053 A1
(43) Pub. Date: Aug. 4, 2016

(54) MOBILE VISUAL COMMERCE SYSTEM

(71) Applicant: Clear Research Corporation, San Francisco, CA (US)

(72) Inventors: Jonathan Romley, San Francisco, CA (US); Dmytro Mishkin, San Francisco, CA (US)

(21) Appl. No.: 15/011,160

(22) Filed: Jan. 29, 2016

Related U.S. Application Data
(60) Provisional application No. 62/109,584, filed on Jan. 29, 2015.

(51) Int. Cl. G06Q 30/06; G06K 9/78; G06K 9/62; G06K 9/48; G06T 7/00; G06K 9/66

(52) U.S. Cl. CPC G06Q 30/0623; G06T 7/0081; G06K 9/66; G06K 9/6267; G06K 9/6201; G06K 9/481; G06K 9/78; G06T 2207/20132

(57) ABSTRACT

A visual commerce engine can provide information related to an object based on an image of the object. The visual commerce engine receives from a user device an image of an object and a location within the image associated with the object, and analyzes the image to detect potential objects depicted in the image. From this set a detected object can be selected based on the received location's proximity to any of the detected potential objects. A description of the detected object can then be determined and compared with a library of objects to identify similar, identical, or related objects.

This application claims a benefit of, and priority to, U.S. Provisional Patent Application No. 62/109,584, filed Jan. 29, 2015, and titled “Mobile Visual Commerce System” which is hereby incorporated by reference herein.

### BACKGROUND

1. Field of Art

The disclosure generally relates to machine learning and image processing in a visual commerce system.

2. Description of the Related Art

Currently mobile device consumers can identify and then purchase off-the-shelf merchandise using a camera and a mobile device application. Such applications use recognition or classification systems to convert captured images to full text searches, or transform entire scenes into a complex fingerprint of visual features and geometry. These methods require a single dominant subject in the image, relying on identifying exact features such as text, color, texture or geometric structure. While such methods may provide efficient performance on objects with minimal features (e.g., books, barcodes, logos, and landmarks), they are not efficient at providing results in visual environments that are realistic, noisy, and/or highly populated. Such methods also are inefficient when providing results where human perception of similarity is fuzzy (e.g., cars, furniture, and clothing). Existing search techniques additionally use variations of an exact match paradigm. However, human perception of similarity is often more approximate than exact, and similarity cannot be represented effectively using an actual distance function between features.

Accordingly, there is lacking an approach using approximate similarity based object detection and a mobile device equipped with camera to identify objects from an input image or video frame.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 is a block diagram illustrating an example environment in which a visual commerce engine might operate.

FIG. 2 is a block diagram of an example visual commerce engine, according to one embodiment.

FIG. 3 is a block diagram of an example object detection module, according to one embodiment.

FIG. 4 is a block diagram of an example object categorization module, according to one embodiment.

FIG. 5 illustrates the structure of an example convolutional neural network, according to one embodiment.

FIGS. 6a and 6b illustrate an example processing flow for one embodiment of a visual commerce system.

FIG. 7 illustrates an example processing flow of an image, according to one embodiment.

FIG. 8 is a flowchart of an example process for detecting objects from an image, according to one embodiment.

FIG. 9 is a further example process flow of an image of an object, according to one embodiment.

FIG. 10 is a flowchart of an example process for generating a description of an object from an image of the object.

FIGS. 11a and 11b illustrate an example user interface of a mobile visual commerce interface, according to one embodiment.

FIG. 12 is a flowchart illustrating one embodiment of a mobile visual commerce system process.

FIG. 13 is a block diagram illustrating an environment in which an example visual commerce engine operates.

FIG. 14 is a block diagram illustrating components of an example machine able to read instructions from a machine-readable medium and execute them in a processor.

### DETAILED DESCRIPTION

The figures (FIGs.) and the following description relate to preferred embodiments by way of illustration only. It should be noted that, from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

In some embodiments, a visual commerce engine receives an input and analyzes an input image to determine an object of interest depicted in the input image received by the visual commerce engine. An input image can be any image, such as a digital photograph, digitally generated image, or video frame, input into the visual commerce engine to be analyzed. In some embodiments, input images depict or represent one or more physical objects, or in some cases classes of physical objects. For example, an input image can be a photograph of an object including at least one object of interest. An object of interest is any object depicted in an input image selected, for instance by a user of a user device or another connected system, to be analyzed by the visual commerce engine. The visual commerce engine can categorize, describe, or otherwise determine information about an object of interest based on its depiction in the input image, and can compare the object of interest to other stored objects or categorization rules. The results of this comparison can be a list of objects similar to the object of interest, a list of other references to or instances of the object of interest, or a relevant categorization of the object of interest. For example, on receiving an input image depicting a watch on a wrist, a visual commerce engine could detect the watch as the object of interest and return a listing of other watches appearing similar to the watch in the input image. In some configurations, the visual commerce engine can take into account additional information in this process, for example, by receiving user input used to select an object of interest.

### Example Operating Environment

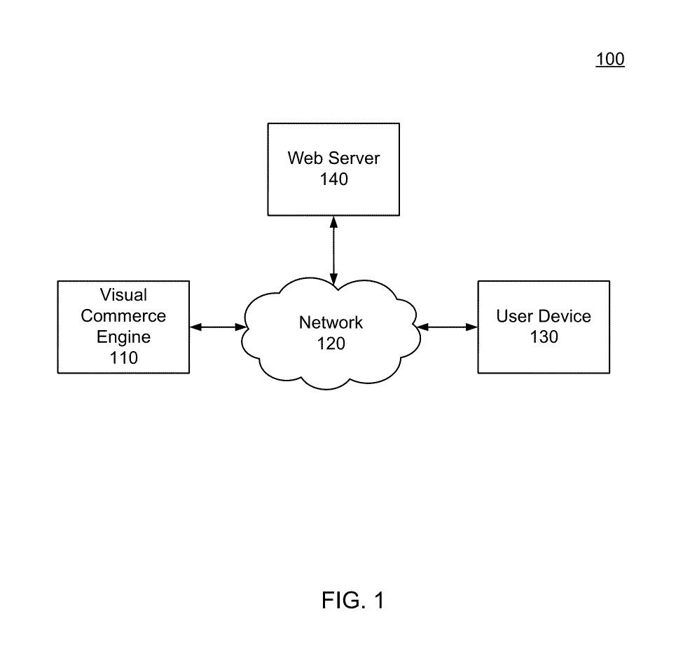

FIG. 1 is a block diagram illustrating an example environment in which a visual commerce engine might operate. The environment 100 shown by FIG. 1 includes a visual commerce engine 110, network 120, user device 130, and web server 140. Only one web server 140 and user device 130 have been shown in FIG. 1, but embodiments can include many (e.g. tens, hundreds, thousands, or millions, etc.) web servers 140 and user devices 130. Each web server 140 or user device 130 may be networked together. Similarly, the web server 140 and the visual commerce engine 110 are shown as separate entities in the embodiment of FIG. 1, but in other embodiments the visual commerce engine can be integrated within a web server 140, or other system. A visual commerce engine 110 is a computing system capable of receiving and analyzing an input image, determining from the input image a relevant object or objects, and returning information based on the relevant objects. In some embodiments, a visual commerce engine 110 receives a query or request for a specific kind of information along with an input image. In these implementations returned information can be additionally based on a type of the received query. For example, a query can be an object query instructing the visual commerce engine 110 to return information on objects similar to objects in the input image, an object entry request instructing the visual commerce engine to analyze the input image and add any determined information to an internal database of the visual commerce engine, or a tariff query instructing the visual commerce engine 110 to return a customs classification for the depicted object.

A network 120 can comprise any combination of local area and wide area networks and can be wired, wireless, or a combination of wired and wireless networks. For example, a network 120 can use standard communication protocols, for example hypertext transport protocol (HTTP) or transmission control protocol/Internet protocol (TCP/IP) over technologies such as Ethernet, Long Term Evolution (LTE), 4G, 5G, digital subscriber line (DSL), or a cable network. In some implementations, data transmitted over the network 120 can be encrypted in whole or in part.

A user device 130 can be a mobile phone, mobile device, smartphone, laptop or desktop computer, tablet, or any other computing device that can be used to interface electronically with a web server 140 or the visual commerce engine 110. User devices 130 can communicate with a web server 140 and/or a visual commerce engine 110 and can be capable of transmitting images depicting an object and receiving corresponding data in return. In some embodiments, user devices 130 can collect and provide a designation or selection that indicates a particular point or region of interest in an input image (hereinafter a “localization indication”) of an object in an image. For example, a localization indication can be a set of coordinates selecting a location of an object of interest in an image sent to the visual commerce engine 110 for analysis. Localization indications can be provided automatically by the user device 130 or input by a user operating the user device 130. According to some implementations, user devices 130 are associated with one or more users able to operate the user device 130. In some embodiments, a user device 130 is associated with a user profile associated with the web server 140 or the visual commerce engine 110. These user profiles can be associated with a user operating or associated with the user device 130. In some embodiments, a user device 130 includes a camera capable of capturing images, such as the camera of a smartphone.

A web server 140 is a website, application, web-application, database, or other network connected system which transmits or receives information from the visual commerce engine 110. In some embodiments, web servers 140 are connected to the visual commerce engine 110 over a network 120, but the visual commerce engine 110 and a web server 140 can also be directly connected, such as by a direct Ethernet connection, or a web server 140 can be integrated into the same computing system as the visual commerce engine 110. In some embodiments, a web server 140 can communicate with a visual commerce engine 110 and can be capable of transmitting images depicting an object to a visual commerce engine 110 and receiving corresponding data in return. In some embodiments, a web server 140 additionally provides a localization indication of an object in an image, such as a localization indication received from a user device 130 or a localization indication generated by the web server 140.

### Visual Commerce Engine

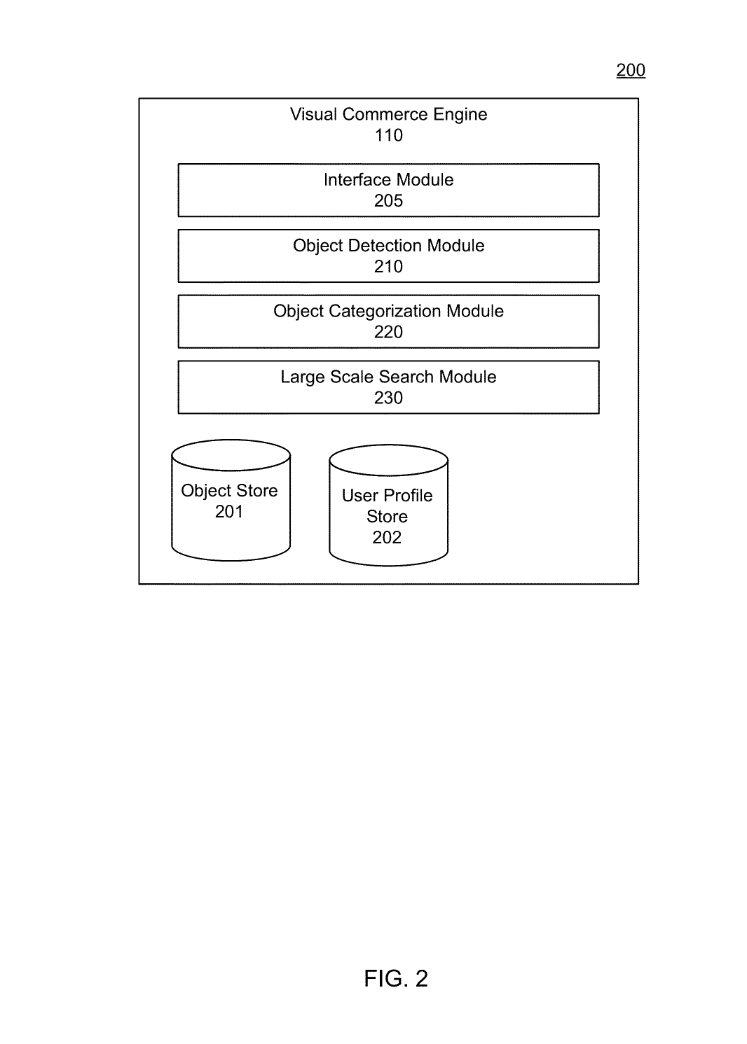

FIG. 2 is a block diagram of an example visual commerce engine 110, according to one embodiment. The visual commerce engine 110 depicted in the embodiment of FIG. 2 includes an object store 201, user profile store 202, interface module 205, object detection module 210, object categorization module 220, and large scale search module 230. In other embodiments, the visual commerce engine 110 can include additional, fewer, or different modules or stores than the ones depicted in FIG. 2. For example, the functions of multiple modules may be combined into one module, or the functions of one module may be split across multiple modules.

In the embodiment of FIG. 2, the object store 201 contains representations of objects known to the visual commerce engine. An object within the object store 201 can be represented by an image of the object, a feature vector, such as a feature vector extracted from an image of the object, a list of parameters or characteristics of the object, or by any combination of suitable means. For example, the object store 201 can contain a library of pictures of different models of watches. The object store can also contain a set of feature vectors, each extracted from and associated with an image of a different model of a watch. Additional information relating to each object can be included within the object store 201, for instance a name of the object, purchase information for the object, a web link associated with the object, or any other suitable descriptive information such as a customs classification for the object. In some embodiments, the object store 201 can additionally or alternatively store classification rules containing instructions to be followed if an input image depicts an object of a specific class. In some implementations, the object store 201 is a database used to store the objects, rules, and other data associated with the object store 201.

The user profile store 202, in the configuration of FIG. 2, stores user profiles containing data associated with users of the visual commerce engine or a related service, such as an associated web server 140. User profiles can include identification information, demographic information, shipping information, preference information, and any other information describing a user. Additionally, a user profile can contain information describing actions of the user or objects the user is associated with, or interacted with the user. For example, if a user transmits an image to the visual commerce engine 110, that action may be stored in the user profile for that user. Similarly, the transmitted image and any object associated with that image can also be included or referenced in the user profile associated with that user. Such data describing the actions or preferences of a user can be collectively known as “user interaction records.”

The interface module 205 manages communications, in some embodiments sent over a network 120, between the visual commerce engine 110 and outside entities, such as user devices 130 or web servers 140, according to the embodiment of FIG. 2. The interface module 205 can receive input images, additional information associated with the input image, and related queries. In some embodiments, the interface module 205 can also receive a type of query instructing the visual commerce engine about a type of information requested by the user device 130 or web server 140 submitting the input image. Additional information received by the interface module 205 can include a localization indication, such as a set of coordinates selecting a location of an object of interest in the input image. For example, the interface module 205 can receive an input image, an associated localization, and a query requesting objects similar to the object selected by the localization indication. Additionally, the interface module 205 can transmit information from the visual commerce engine to user devices 130 or web servers 140. For example, transmitted information can include query results such as such as information about an object of interest depicted in the image, information about objects similar to objects depicted in the image, or other relevant information about the object of interest.

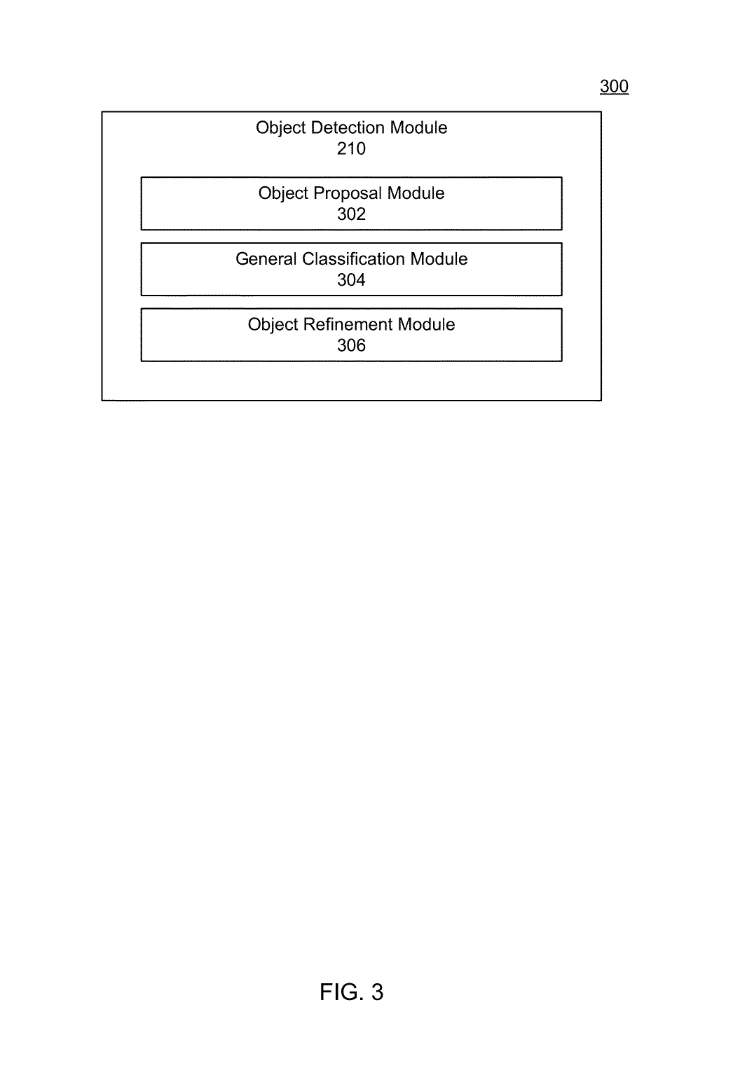

In the embodiment of FIG. 2, the object detection module 210 analyzes an input image and determines the locations of objects present within the image. In some embodiments, the object detection module 210 generates a cropped image focused on a single detected object (hereinafter, an “object image”) for each detected object within the input image. For example, if the object detection module 210 receives an input image of a red circle and a green square adjacent to each other on a featureless background, the object detection module 210 can generate an object image for the red circle, such as a cropped image of the red circle, and an object image for the green square. In some implementations, only a specific number of object images for detected objects are generated, or only object images including regions of the input image close to a selected part of the image are generated. The object detection module 210 can also receive other information along with the image, for example a localization indication, or an indication of the number of objects of interest present in the image. Additionally, the object detection module can generally classify each detected object into an overall category describing a general class of items it belongs to, in some embodiments through the use of a convolutional neural network or other machine learning system. The object detection module will be discussed in further detail below in relation to FIG. 3.

The object categorization module 220, according to the configuration of FIG. 2, analyzes an input image containing an object of interest to determine features or characteristics of the object of interest depicted in the input image. In some implementations, the object categorization module 220 receives a cropped object image for an object of interest. The object categorization module 220 can also receive a general classification of the object of interest and refine the input image before or during the analysis. For example, the object categorization module 220 can remove the background of an image before it is analyzed, or as the result of an initial analysis. In some embodiments, analysis of the input image is performed using a convolutional neural network or other machine learning system and generates a feature vector describing the object of interest. The object categorization module 220 will be discussed in further detail below. In some embodiments, feature vectors generated by the object categorization module 220 can be stored in object store 201 to be later referenced in relation to other requests.

In the embodiment of FIG. 2, the large scale search module 230 compares an input object, such as a description of an object of interest with other objects or rules stored in the object store 201. In some embodiments, an input object is an object detected in an input image, but an input object can also be an object stored within object store 201, or any other suitable object. The large scale search module 230 can generate a list of objects identical to the input object, objects similar to the input object, objects related to the input object, or other relevant information about the input object. In some embodiments, the large scale search module returns objects based on a query or type of request received at the visual commerce engine. For example, if a tariff query is received the large scale search module 230 can return a customs classification for the relevant object. The large scale search module 230 can search the object store 201 for relevant objects by comparing a feature vector of the input image with feature vectors of objects in the object store 201, or by any suitable searching method. In some embodiments, the large scale search module 230 can utilize a metric inverted indexing method to perform the similarity search, however, in other embodiments, techniques such as kd-tree, feature binarization, or Hamming distance search can be used separately or in combination to perform the similarity searches.

By way of example, to perform similarity searches, the large scale search module 230 calculates a distance between given descriptors (i.e., a vector of numbers) and a set of reference objects from the database for a determined category, such as the category of the object of interest. In one embodiment, the form of representation is universal for any category or object, but the actual description is unique to each object categories to output the nearest semantic neighbors for given queries. Objects from the database which have the same order of closest reference objects are then retrieved and ordered in a result ranking. In some embodiments, there are no objects from the database that are an exact match with the object of interest. Accordingly, top ranked objects are selected based on a similarity between the query object and the closest reference object order as well as sort by difference values. Moreover, the system can be configured so that a top N (N being an integer value) objects which have almost the same order of closest reference objects as the query object, sort by difference, and take the N (N being an integer value) of best objects. Because users can have product specific preferences (e.g., natural fabric, price limit, or very specific understanding of “similarity”), top results 245 may be re-ordered and displayed to better match after gathering consumer class, purchase history, and demographics. In some implementations, results can also be selected based on user interaction records. In some embodiments, results can be selected or ordered based on similarity to another object associated with the user, such as an object previously described by the visual commerce engine 110 based on an input image received from a user device associated with the user. According to one implementation, results are selected or ordered based on a visual or stylistic math with objects associated with the user, such as an object purchased by the user through the visual commerce engine. For example, if a user is associated with red high heels, large scale search results for other categories (e.g. tops or handbags) can be ordered to prioritize objects that visually match or complement the red high heels associated with the user. In some embodiments, a user is also associated with a visual style, such as hiking clothes, sportswear, or prep. In these embodiments, large scale search results that are a visual match with the visual style can be prioritized.

By way of further example, the large scale search module 230 can utilize a metric inverted (MI) file model or MI indexing model. A MI file model can perform a fast similarity search in a large scale database. MI file models can be implemented on very large databases of, such as a database of up to 100 million entries. When two entries are very similar, such as when associated feature vectors are very close one to each other they “see” the world around them in a same way. Accordingly, the MI model can use a measure of dissimilarity between the views of the world from the perspective of the two entries in place of the distance function of the underlying metric space. In some implementations, the MI file model represents each entry of a database in relation to a set or lexicon of reference entries, in some instances selected out of the database entries. For example, instead of representing an entry by a full feature vector, the entry can be represented by the distance (i.e., similarity) from the entry to each reference entry in the pre-defined set or lexicon (e.g., A, B, C, D). An entry can also be represented by an ordered list of the reference entries (e.g., C, B, D, A) sorted by minimum distance to the database entry. To compare two entries of the dataset a comparison can be made between the two corresponding ordered lists of reference entries. Efficient and effective approximate similarity searching can then be obtained by using inverted files. Inverted files store the entries in a database, which are closest to the reference object A, B, C, D. Thus, instead of a calculation of the distance from query entry to every entry in the database, the MI file model calculates the distance only to the reference entries, sorts by distance to the reference entries, and retrieves from database only entries that are closest to the first K reference entries. In one embodiment, a recursive use of the MI file module is used to find distances to the reference entries themselves, instead of calculating distances to the full set of the reference entries, which results in a significant increase in search speed.

### Object Detection

FIG. 3 is a block diagram of an example object detection module 210, according to one embodiment. The object detection module 210 can include an object proposal module 302, a general classification module 304, and an object refinement module 306. The object proposal module 302 generates a set of category-independent indications of objects depicted in an input image (hereinafter, “object proposals”), according to the embodiment of FIG. 3. Object proposals generated by the object proposal module 302 can be a specific set of pixels, region of the input image, cropped version of the input image, set of coordinates referencing a position in an input image, mask over the input image, or any indication determined to possibly identify the location or presence of an object in the input image.

In some implementations the object proposal module 302 generates object proposals through the use of conventional “Learning to Propose Objects” (LPO) algorithms. In these embodiments, object proposals are generated using a set of segmentation models independently operating on the input image. In some implementations, each segmentation model segments the input image to determine a single object proposal based on the specific characteristics of that segmentation model. That is, each segmentation model can return a set of pixels in the image or other suitable selection determined to represent an “object” according to the segmentation model. The object proposals generated by the set of all segmentation models can form the output set of object proposals. The makeup of the set of segmentation models can determine the object proposals received. In some implementations, segmentation models are a mixture of global and local conditional random field (CRF) models, but other implementations can use exclusively global CRF models, exclusively local CRF models, or any other combination of suitable image segmentation models. A CRF model can take into account context, for example adjacent pixels in image, when segmenting the input image. Local CRF models can be of the same form as global CRF models, but localized around a specific seed location in the input image. In some configurations, each segmentation model is trained to identify specific common object appearances and different segmentation models can be trained to identify different categories of common objects, for example, the categories of “shoes” and “purses.”

In other implementations of the object proposal module 302, a binarized normed gradient (BING) model generates the category-independent object proposals. A BING model generates object proposals based on refining all possible object windows in an input image, reducing the number of windows in the input image that could contain an object of interest from the hundreds of thousands (caused by different scales, positions, and proportions) to one or two thousand. In the BING model, the image is resized and cropped to a predefined set of sizes/windows and a normed gradient map is calculated for each window. In this implementation, the normed gradient maps are then convolved with a learned objectness filter resulting in a map of the objectness function for each window. The resulting windows can then be ranked based on the objectness function, and in some implementations only a certain number, for example the top 2000 object proposals, are returned. BING methods can provide highly optimized results accomplished with only few atomic operations and SSE instructions.

In the embodiment of FIG. 3, object proposals are associated with a region in the input image potentially containing an object. For example, object proposals can be associated with a bounding box representing the boundaries of each object proposal. In some implementations, a bounding box for an object proposal is calculated by taking the maximum and minimum horizontal and vertical coordinates of the object proposal and constructing a rectangular bounding box using that information.

According to the embodiment of FIG. 3, the general classification module 304 calculates a feature vector for each object proposal. In some implementations, the feature vector is calculated using a convolutional neural network, but the features of each object proposal can be calculated by any suitable method. In some embodiments, each object proposal is converted to an object image for the region it represents before the feature vector is calculated. For example, the object image for each object proposal can be resized and warped to conform to a fixed size, for example 300 by 300 pixels, or 224 by 224 pixels. In some implementations, the fixed size of the generated object images can take into account a fixed border around the object, such as 16 pixels per side. In these implementations, the border size can be pre-calculated before the image is warped and resized, so that the border remains a constant size across all object proposals after being warped. For example, in a case where object proposals are resized to 300 by 300 pixels with a 25 pixel border on each side, in an originally 100 by 200 region, 10 pixels would have to be added to each side horizontally, and 20 to each vertical side leading to a final size of 120 by 240 pixels. Resizing and warping this image to 300 pixels by 300 pixels still results in the expected 25 pixel border around all sides, even though an uneven amount of pixels were added to each side.

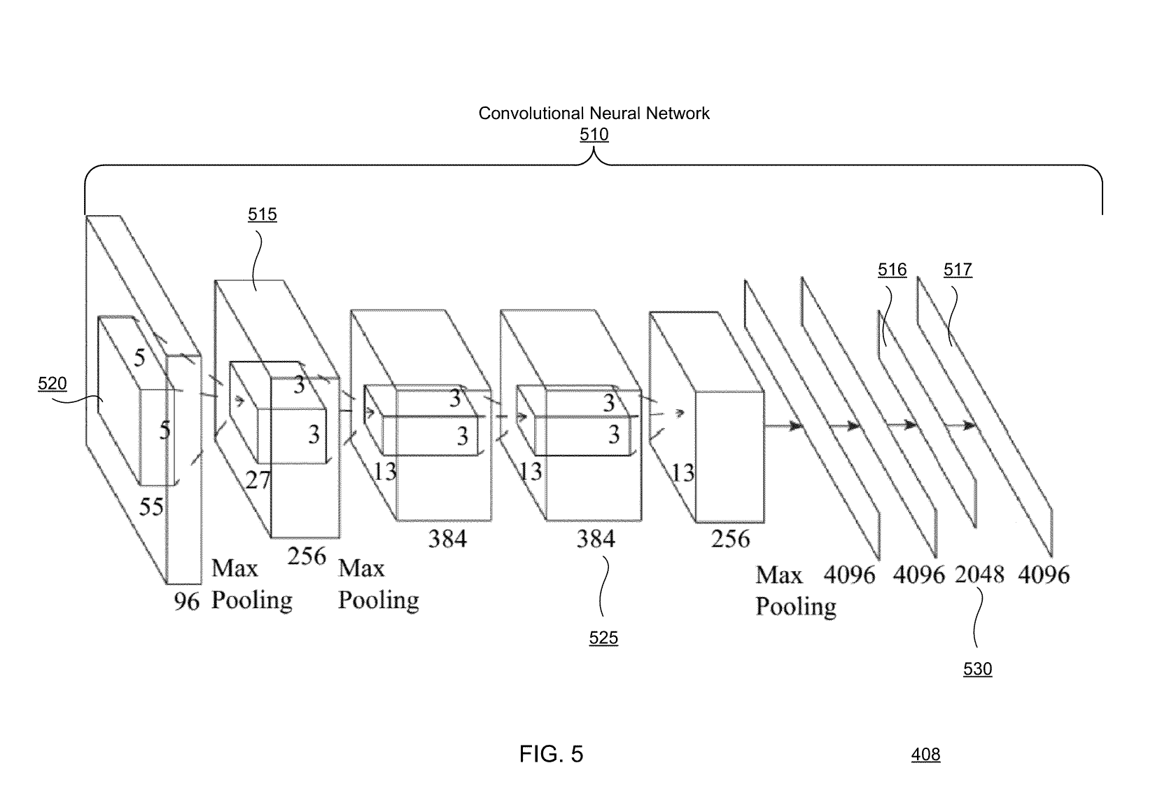

In some implementations, a trained convolutional neural network is used by the general classification module 304 to calculate a feature vector for each object proposal. For example, a deep convolutional neural network, trained on large scale image sets, comprises of set of banks of 3D filters (e.g. Gaussian or Gabor) learned using large scale datasets. Deep convolutional neural networks can be used to calculate feature vectors for an object proposal or object image. Filters are organized in a hierarchical or deep structure such that the output of a filter bank is the input for next layer of filter banks. The convolutional neural network contains several layers of filters; each consecutive layer contains more discriminative description of the input object image. The last layer has a number of outputs equal to a number of classes. The output of the last fully-connected layer can be input into a K-way softmax classifier which produces a distribution over various class labels and determines the classification of the object in the image. FIG. 5 illustrates the structure of an example convolutional neural network, according to one embodiment.

The convolutional neural network 510 comprises convolutional layers 515, weights 520, channels 525 and neurons 530. A convolutional neural network 510 can be used, for example, to generate category-specific descriptions, such as for the category of “shoes,” or to classify an object into a category. The convolutional neural network 510 can be trained on a large auxiliary datasets of approximately one million images with image-level annotations and different classifiers. In some embodiments, a convolutional neural network can be trained or specialized to operate on a certain category of input objects (e.g. a category specific convolutional neural network) to generate descriptions specific to that category of input objects. For example, a category specific convolutional neural network for the category of “shoes” can be trained on a dataset of images of shoes. In other embodiments, a convolutional neural network can be trained on a general dataset of images of objects of different categories. Each convolutional layer 515 of the convolutional neural network 510 contains a fixed number of kernels. The kernels are convolved with an input matrix resulting in output matrices that are transmitted to the following convolutional layer 515. In some embodiments, the output matrixes or transformed image are fed into a rectified linear unit (ReLU) or rectifier non-linearity before being input into the next convolutional layer. For example, an image matrix is fed into the first convolutional layer where it is convolved with 96 kernels. The resulting transformed imaged is then fed into the rectifier non-linearity and then to the second convolutional layer 515 where it is convolved with 256 kernels. Each convolutional layer 515 contains a number of channels 525 that corresponds to the number of kernels utilized in the previous convolutional layer 515. A soft-max classifier layer (not shown) is initially removed from the convolutional neural network 510 and weights 520 of layers 515 one through four are fixed. Two fully-connected layers with rectified non-linearity and drop-out regularization are been added to the convolutional neural network 510. The first new layer 516 has 2048 neurons 530 while the second new layer 517 contains 4096 neurons 530. The convolutional neural network 510 is trained in de-noising auto-encoder style optimizing differences between outputs of the second new layer 517 of the convolutional neural network 510. In some embodiments, the dataset, which used for training, contains only images of the specific category, for example skirts. Training is done until convergence for approximately 30 epochs. The second new layer 517 is removed after a training stage. The 2048-D feature activations of the first new layer 516 neurons 530 are reused as final image descriptors.

Returning to FIG. 3, the general classification module 304 can use the calculated features for each object proposal to classify each object proposal into a general category giving an overarching description of the structure and function of the object proposal. For example, a K-way classifier or other classification method can be used to classify each object proposal into general categories such as “car,” “hat,” “shirt,” “shoes,” and so on.

In the embodiment of FIG. 3, the set of object proposals generated by the object proposal module 302 is refined and reduced by the object refinement module 306 to form a final set of objects of interest determined to be present in the input image. The object refinement module 306 can return a single object or set of objects for a given input image based on user localization input and other factors. In some implementations, a localization indication is provided to the object detection module along with the input image. The provided localization indication can be used to reduce the number of object proposals by eliminating object proposals not related to the area of the input image containing the localization indication. For example, if provided with a localization indicator containing a set of coordinates designating a location on the input image, object proposals not within a threshold distance from the coordinates can be eliminated from the set of object proposals. In one implementation, a radius around the coordinates is calculated and object proposals not containing at least a threshold amount of this area are eliminated. Additionally, classification data, such as a general classification generated by the general classification module 304, associated with each object proposal can be utilized to further refine object proposal boundaries. For example, two overlapping object proposals with the same or similar information can be combined. Further, the object refinement module 306 can be configured to disambiguate a user query, such as between two occluding objects like a bag and dress, based on a localization indication. In another example, a dominant class can be determined for the input image or region of the input image using the classification information and the coordinates of each object proposal. In some configurations, object proposals not of the dominant class are eliminated. In one implementation, remaining object proposals after then dominant class is calculated are averaged to return a single object image associated with an object of interest. In some implementations, a border (for example, 15 pixels on each side) can be added to the final object image to preserve the context of the proposed object within the larger image.

### Object Categorization

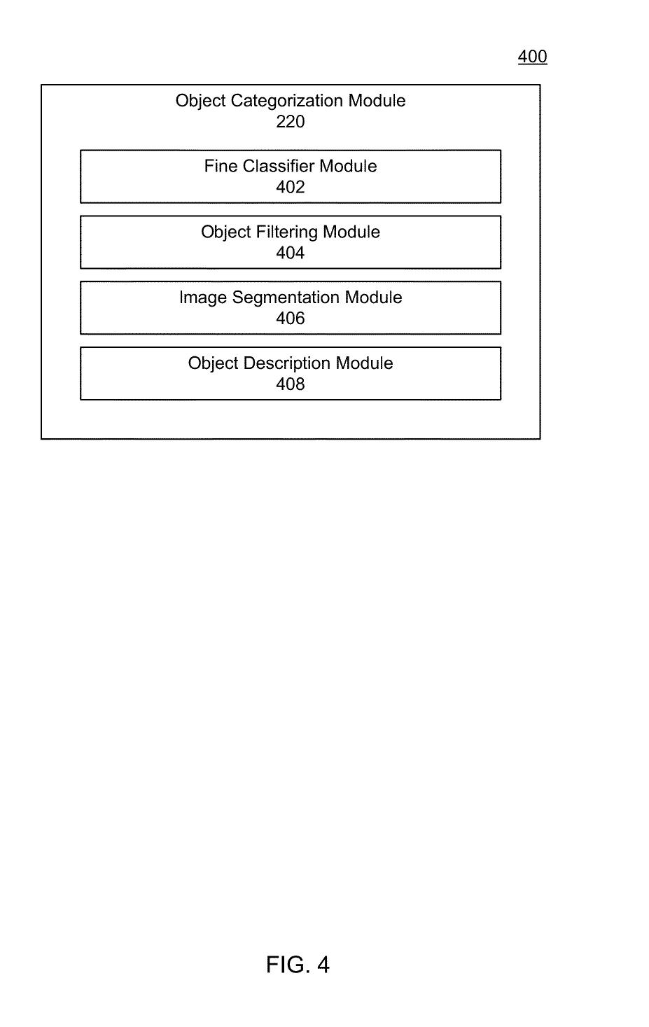

FIG. 4 is a block diagram of an example object categorization module 220, according to one embodiment. The categorization module 220 in the embodiment of FIG. 4 includes a fine classifier module 402, an object filtering module 404, a segmentation module 406, and an object description module 408. In some embodiments, the object categorization module 220 receives an object image from object detection module 210, and further refines and describes the object and associated object image.

The fine classification module 402, according to the embodiment of FIG. 4, classifies an image of an object of interest into a finer or more granular classification of an object based on a general classification of the object. For example, the fine classification module 402 can use a received general classification of an input image to select a category-specific classifier with which to classify the input image. In some embodiments, the fine classification module 402 provides more granular classification of objects received from and already classified by the general classification module 304. In some implementations, the fine classification module 402 uses a functionally identical convolutional neural network to the neural network used in the general classifier module 304, but refines the classification of input images to a more precise level than the general classification returned by the general classifier module 304. Embodiments of the fine classification module 402 can contain fine classifiers for each general classification, such as multiple convolutional neural networks each trained for a possible general classification returned by the general classification module 304. In some embodiments, an image already classified by the fine classification module 402 is backpropagated through the fine classification module 402 to determine or detect portions of the image that match the fine classification. In one implementation, portions or regions of an input image are determined to be indicative of the object, or not indicative of the object based on this back propagation. In some embodiment, classified input images as well as information about regions indicative of the object can be sent to a segmentation module 406 for further refinement.

In the configuration of FIG. 4, the object filtering module 404 can filter an input image to identify background areas or other unwanted features of the input image. In the configuration of FIG. 4, an input image is an object image depicting a single object of interest in context with its surroundings. Even if the input image is closely cropped around the bounds of the object of interest, additional unwanted or extraneous features may still be present. For example, in the case where the object of interest is a wristwatch or other roughly circular object, a cropped image will contain background features at the corners of the object, such as portions of a wrist the watch is being worn on. Removing these additional features can improve the ability of image classifiers to operate on the input image. Returning to the previous example of the wristwatch, the object filtering module 404 can, for example, detect skin visible in the input image and generate a mask that can be used to remove the background feature of the skin. The input image can later be filtered using the generated mask and later classification results can be more accurate due to the removal of background objects in the image. According to some embodiments, the object filtering module 404 operates in parallel with or concurrently with the fine classifier module 402, but in other embodiments these modules can operate sequentially, or in any other ordering.

Any suitable image processing techniques to remove specific unwanted features in an image can be implemented in the object filtering module 404, according to some embodiments. In some implementations, the object filtering module 404 includes a skin detection function configured to identify skin present in an object image. A skin detection function can be implemented by a random forest classifier (Khan, Hanbury, and Stoettinger, 2010) and can be used to detect skin present in the input image and generate a background mask. Skin detection by random forest classifier can use raw pixel intensities in different color-spaces and differences between pixel intensities to detect pixels likely to represent skin. In some implementations, the random forest method is based on averaging results from several decision tree classifiers. Each decision tree classifier splits a range of each variable (e.g. pixel intensity) into sub-ranges (e.g. skin or non-skin) according to training data. An ensemble of such classifiers can classify each pixel as “skin” or “non-skin”, and the set of pixels classified as “skin” can then be treated as a mask of the image. This mask can be later used to segment or otherwise modify the object image.

The image segmentation module 406 attempts to separate the object of interest from its background, so the object of interest can later be more accurately described. The image segmentation module 406 can generate an image containing an object of interest with a transparent, solid color, or otherwise removed background, such as a background with some features, such as skin, removed (hereinafter, a “segmented image”). In some implementations, the image segmentation module 406 utilizes grabcut segmentation techniques to separate the image background from the identified object. A grabcut algorithm can iteratively separate background pixels and identified foreground object pixels using pixel intensities and connectivity; and a mutual location of surrounding pixels. Image pixels can be labeled as foreground or background based on previous inputs from the fine classifier module 402, or the object filtering module 404. In some implementations, two penalties occur in the grabcut algorithm occurring when pixels are adjacent and have different labels, and when the color of a pixel is closer to the estimated color model for a background pixel, but the pixel is labeled as a foreground pixel, or vice versa. The minimum penalty for the whole image corresponds to the optimal image segmentation and is estimated by iterative convex optimization methods. The grabcut algorithm can output a mask indicating background pixels in the input image. In some cases the grabcut algorithm is initialized using an output mask from the object filtering module 404. In some embodiments, the image segmentation module 406 applies the grabcut generated mask to the input image and outputs a segmented image with background removed.

In some implementation, the object description module 408 generates a description for an object of interest that can be used to compare the object of interest with other objects. The object description module 408 is, according to some embodiments, a category-specific convolutional neural network which describes an object of interest based on an input image. In some embodiments, the received image is a segmented image including an object of interest and a plain or transparent background. The object description module 408 can also receive categorization information about the object of interest to aid in the category specific description. For example, the object description module 408 can receive classification or categorization information from the fine classifier module 402. In some implementations, a convolutional neural network is used to generate the category specific description, and the category specific description is in the form of features of the input image determined by the convolutional neural network to describe characteristics or features of the object of interest. These characteristics can then be associated with the object of interest or input image, for example in object store 201. In some embodiments the category-specific description of the input image is used to determine other similar objects to the object of interest.

### Exemplary Process of Visual Commerce Engine

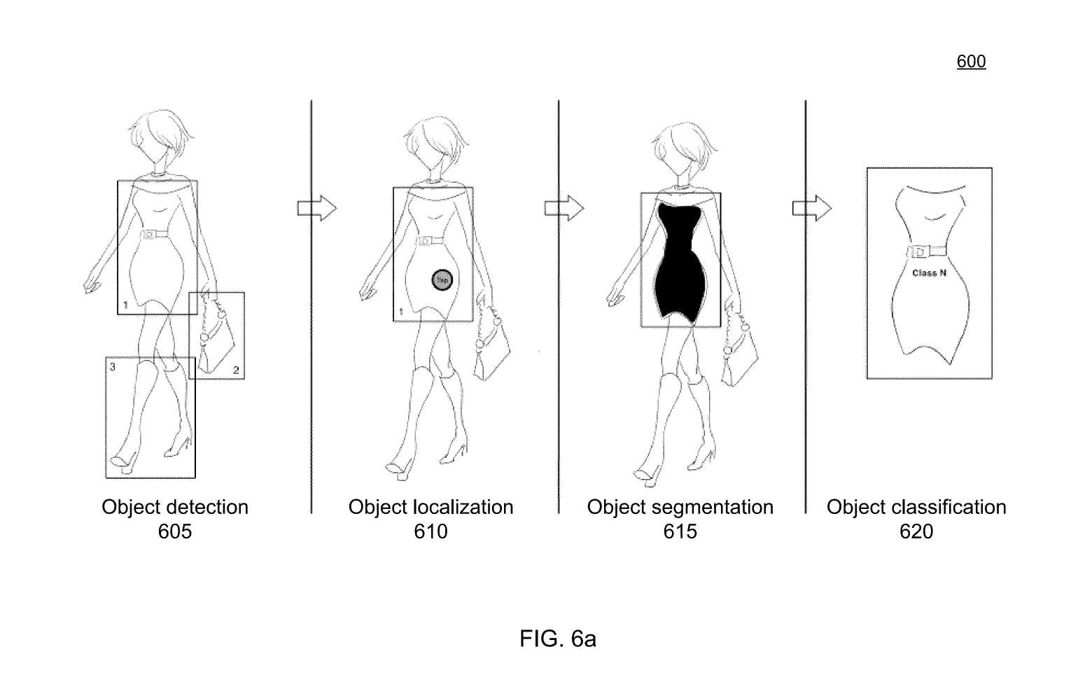

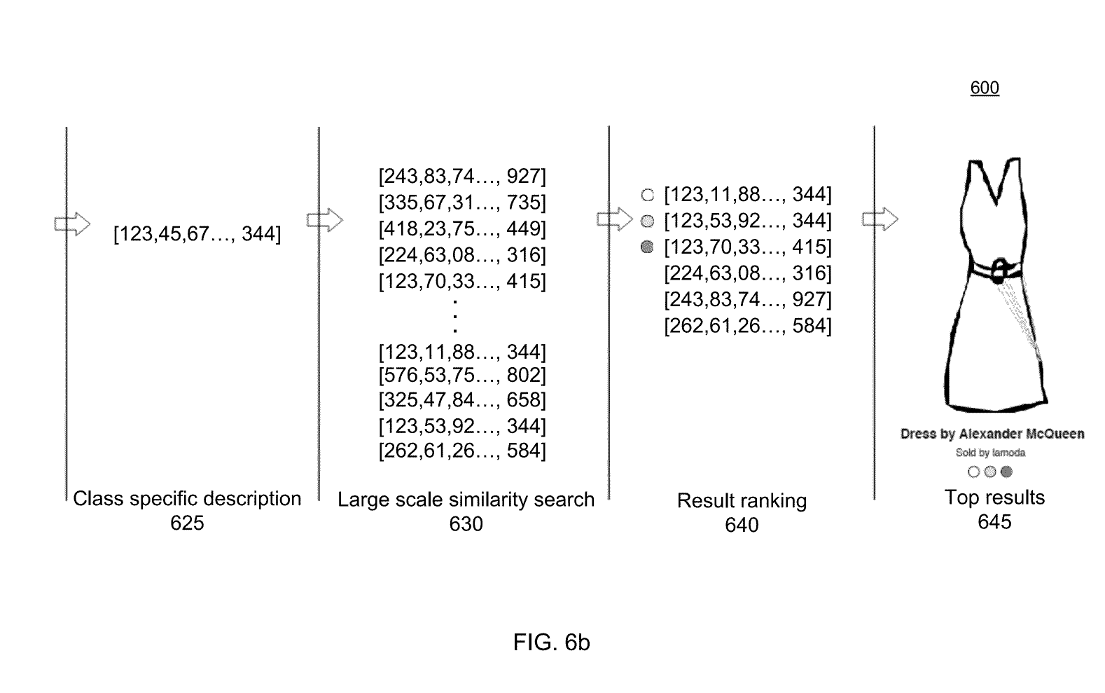

FIGS. 6a and 6b illustrate an example processing flow for one embodiment of a visual commerce engine. FIG. 6a illustrates an example process by which an input image is classified. In this example, the process begins with several object proposals being detected 605 in the input image and subsequently presented to the user for input. For example, the visual commerce engine 110 can detect possible products in the input image and highlights the detected objects by surrounding them with numerically labeled boxes on a user interface of a user device 130. In the case of FIG. 6a the visual commerce engine 110 has detected a purse, a dress, and boots in numerically labelled boxes 1, 2, and 3, respectively. When the user provides 610 localization information one object proposal is selected as the object of interest. In this example, an object of interest is selected by tapping the corresponding numbered box, thereby providing a localization indication of the object of interest to the visual commerce engine 110. The selected object of interest is then segmented 615 (represented here by a black mask highlighting portions of the input image determined to be part of the object of interest) and cropped to remove background portions of the input image not relevant to the object of interest represented here by the bounding box in image 615. The segmented image is then classified 620 to determine a classification or category of the object of interest. For example, a convolutional neural network can be used to describe segmented images, transforming them from raw pixels to an object classification that can determine which subset of databases to search when looking for similar objects.

FIG. 6b begins with a class specific description 625, in this case a feature vector describing an object of interest. For example, the class specific description 625 can be the result of the image classification 620, and, in some embodiments, the class specific description determines which subset of databases to search when looking for similar objects. The class specific description 625 can then be compared to databases of objects or rules in a large scale similarity search 630, for example, using a MI file model. In some implementations, the large scale similarity search returns a result ranking 640 indicating other objects similar to the object of interest. The top results 645 can then be ordered and returned to the user device 130 or web server 140 of the user based on level of similarity and user interaction records.

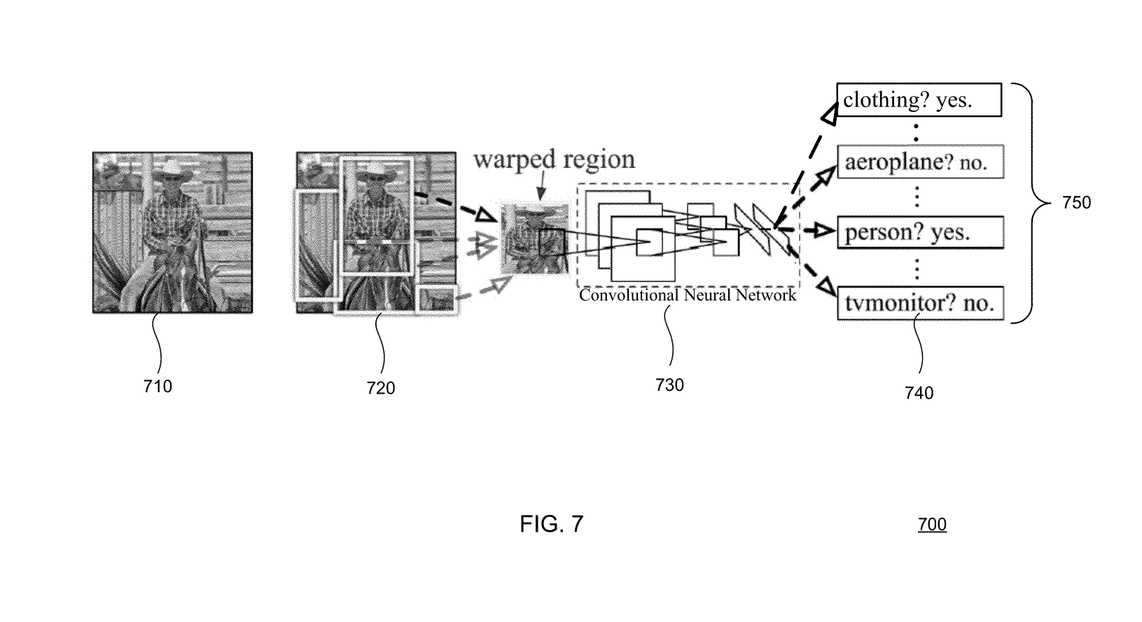

FIG. 7 illustrates an example processing flow of an image, according to one embodiment. In the embodiment of FIG. 7, an object detection and localization portion of the pipeline includes an input image 710 which is operated on by a series of modules. The image 710 is first analyzed by an object proposal module 720 to determine object proposals. For example, the object detection module can be a binarized normed gradient (BING) module which generates category-independent region proposals for the image 710. Object proposals extracted from the input image 710 can then be analyzed by a general classification module 730. In some embodiments, a general classification module 730 is a large convolutional neural network that extracts a fixed-length feature vector from each region. A general classification module can also include a k-way softmax classifier 740 which can identify a class (e.g. clothing) and assign a corresponding class score for each object proposal. The classified object proposals can then be filtered and combined 750 based on their score, class, and overlap to form a final object of interest. For example, the final object can be the object closest to the object identified by a localization indication such as touch coordinates.

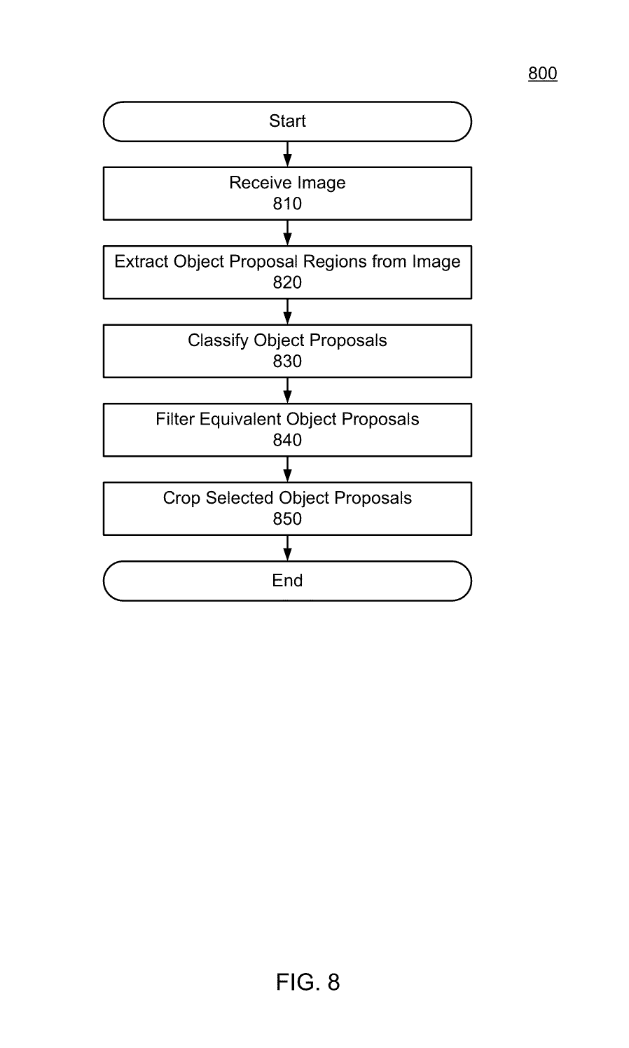

FIG. 8 is a flowchart of an example process for detecting objects from an image, according to one embodiment. The process of FIG. 8 begins when the visual commerce engine 110 receives 810 an input image depicting one or more objects of interest. The visual commerce engine 110 can then extract 820 one or more object proposals, such as a proposed region containing an object, from the input image. The extracted object proposals can then be classified 830 and filtered 840 to eliminate redundant or extraneous object proposals. The remaining object proposals can then be cropped 850, for example to include contextual information with the object in an object image.

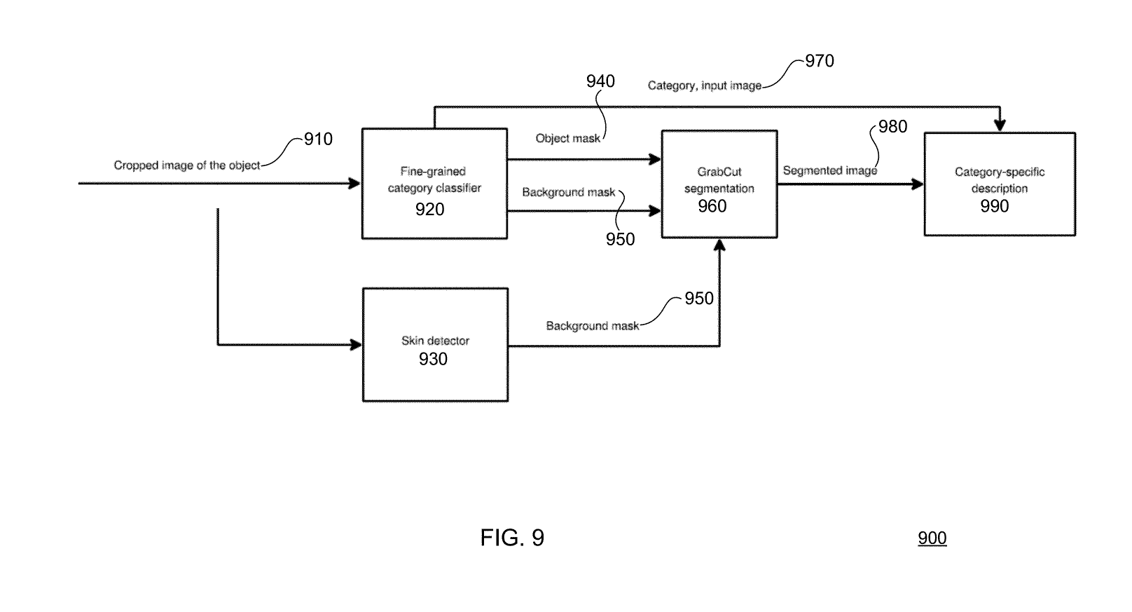

FIG. 9 is a further example process flow of an object, according to one embodiment. In the embodiment of FIG. 9, the segmentation and description portion of the image processing flow comprises a fine-grained classifier module 920, skin detector module 930, grabcut segmentation module 960, and a category-specific description module 990. The segmentation and description portion of the image processing flow receives a cropped image of an object of interest 910 which is then sent to a fine-grained classifier module 920 to classify the cropped image of an object of interest 910. In some embodiments, the fine-grained classifier module 920 also generates an object mask 940 and background mask 950 for the image. For example, the fine-grained classifier module 920 can back-propagate the classification through a fine-grained classifier, such as a trained convolutional neural network used to generate the fine-grained classification, to generate the object mask 940 and background mask 950. In the embodiment of FIG. 9, a skin detector module 930 is run in parallel and detects human skin in the input cropped image of the object. This information can be user used to improve the background mask 950. In some embodiments, the input object image for the object of interest is then segmented by the grabcut module 960 using the object mask 940 and background mask 950. In some implementations, the segmented image 980 is then centered and mean-image padded before being categorized by a category specific description module 990. The category specific description module 990 can use a category-specific convolutional neural network trained based on a specific category. In these embodiments, the last layer activations of the category specific convolutional neural network are used as image descriptors to describe the object of interest.

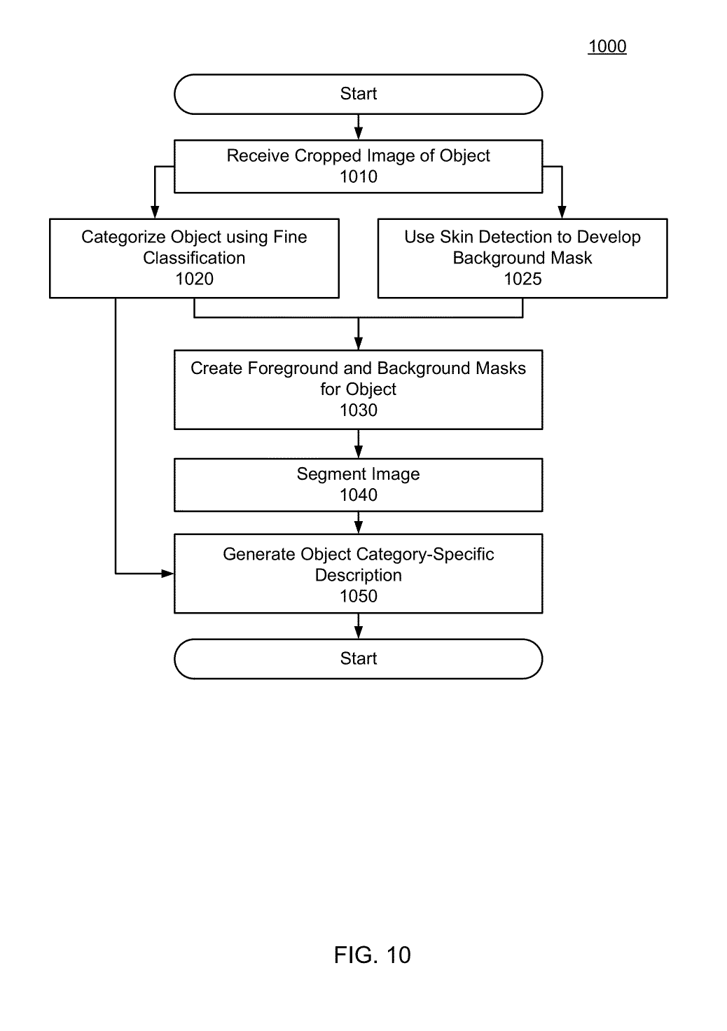

FIG. 10 is a flowchart of an example process for generating a description of an object from an image of the object. Process 1000 begins when the object categorization module 220 receives 1010 an object image for an object of interest. The received object image is then categorized 1020 in detail, for example by a fine classification module, to determine a categorization for or characteristics of the object of interest. In parallel, the object image is analyzed 1025 using skin detection techniques to develop a partial background mask for the object image. This background mask is used along with the classification information from step 1020 to generate 1030 foreground and background masks for the object of interest. The generated masks are then used to segment 1040 the object image into an “object” segment containing the object of interest and a “background” segment containing other features of the object image. The segmented image is then combined with the classification information to generate 1050 a category specific description of the object of interest.

### Exemplary Mobile Visual Commerce Implementation

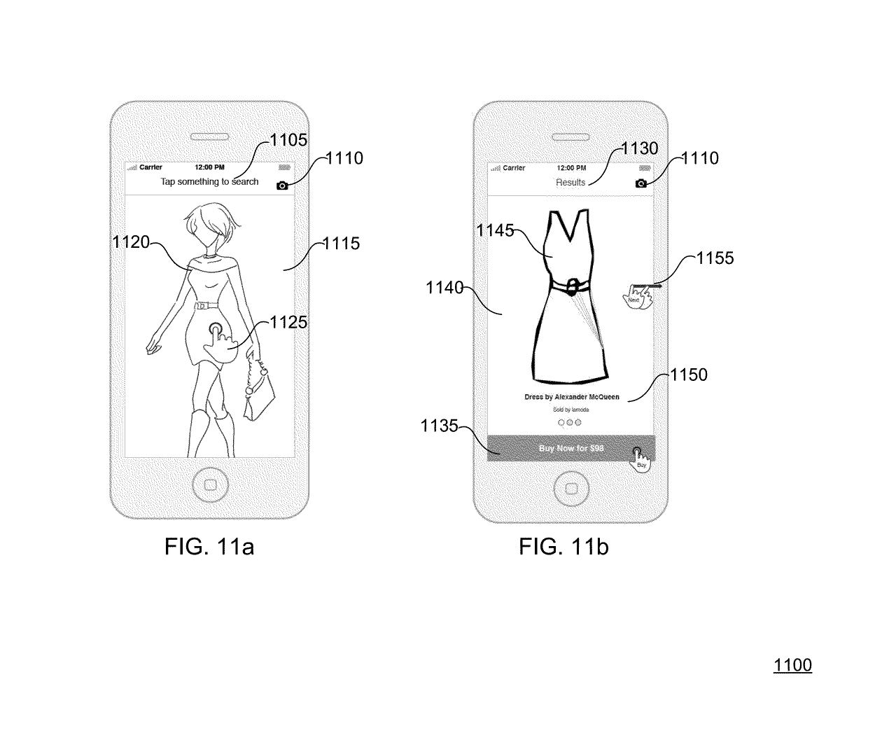

In some embodiments, a visual commerce engine 110 is used to facilitate the discovery and purchase of a product based on images of that product or other similar products. A product can be a consumer good purchasable by a user, such as an off-the-shelf item, car, or piece of furniture. One implementation includes using a user device 130 with a camera and a user interface (as shown in FIGS. 11a. and 11b) to identify products for purchase based on an image captured with the user device's camera. For example, a user may want to purchase a pair of shoes similar to a pair owned by a friend. Using this implementation, the user can capture a product image of one of the shoes, such as by taking a photo on a user device 130 and, using the user interface of this implementation, give a localization indication (such as by giving the coordinates of the shoes within the product image). The visual commerce engine 110 then analyzes this product image to determine the characteristics of the indicated product (in this case the shoes) and returns data related to similar products. In this implementation, the visual commerce engine 110 can return information about the shoes depicted in the input image or information about other similar shoes.

FIGS. 11a and 11b illustrate an example user interface of a mobile visual commerce interface, according to one embodiment. In some implementations, the user interface 1100 shown in FIGS. 11a and 11b is displayed on a user device 130 of a user and allows the user to interact with a user device 130. In this embodiment, the user interface 1100 includes a product image screen 1105 and a results screen 1130. Embodiments can also include a camera screen (not shown) that can be accessed through a camera access shortcut 1110. The camera screen can allow a user to capture a product image using a camera of the mobile device 130.

In the embodiment of FIG. 11, a product image screen (shown in FIG. 11a) allows a user to view and augment a product image before it is transmitted to the visual commerce engine 110. For example, a product image can be augmented with a localization indication or cropped by the user before being sent to the visual commerce engine 110 as an input image. A product image screen can include a camera access shortcut 1110, product image 1115, indicated product 1120, and localization indication 1125.

A product image 1115 can be any image generated or stored on the user device 130 to be input for analysis by the visual commerce system 110. For example, a product image can be an image captured by a camera of the user device 130, an image downloaded from a website, or any other suitable image. In some embodiments, an indicated product 1120 is a product or object depicted in a product image 1115. For example, an indicated product 1120 can be a watch, bag, hat, or chair about which a user wishes to find similar examples to purchase. A localization indication 1125 is, as discussed earlier, an indication of the location within an image of an object of interest. In some implementations, a localization indication 1125 includes the coordinates of an indicated product 1120 within a product image 1115. For example, a user can input a localization indication into user interface 1100 by tapping on the indicated product 1115 depicted in the product image.

A results screen 1130, as shown in FIG. 11b, allows a user to view information on results received from a visual commerce engine 110, according to some embodiments. In this embodiment, results screens 1130 can include any information on relevant products. For example, a results screen 1130 can include information on the product shown in the product image or a similar or related product determined by the visual commerce system 110. A results screen can include a camera access shortcut 1110, buy shortcut 1135, result image 1140, result object 1145, result information 1150, and a next result gesture 1155.

In some embodiments, a buy shortcut 1135 is a link or redirect that allows a user to easily purchase or find information on the result object 1140 shown on the results screen 1130. In some embodiments, the buy shortcut 1135 directs the user to an associated online marketplace stored on a webserver 140 associated with the visual commerce engine, but in other embodiments the user can be directed to a page or website containing any other relevant information on the result object 1140.

A result image 1140, in the embodiment of FIG. 11, is an image or representation of a result object returned to the mobile device 130 by the visual commerce engine 110. A result object 1145, in some implementations, is a product similar or identical to the product depicted in the original product image 1115 about which information is known. Known information about a result can include a price or name of the product, purchase instructions or availability information about the product, or any other suitable information about the product. Certain implementations include a next result gesture 1155 that enables a user to move between results returned to the user device 130.

In some embodiments, a results screen 1130 includes result information 1150 giving information on results objects 1145 received by the user device 130. For example results information can include the name or price of a product, a number of results returned, a type of a product, a seller of a product, or any other relevant information about returned results objects.

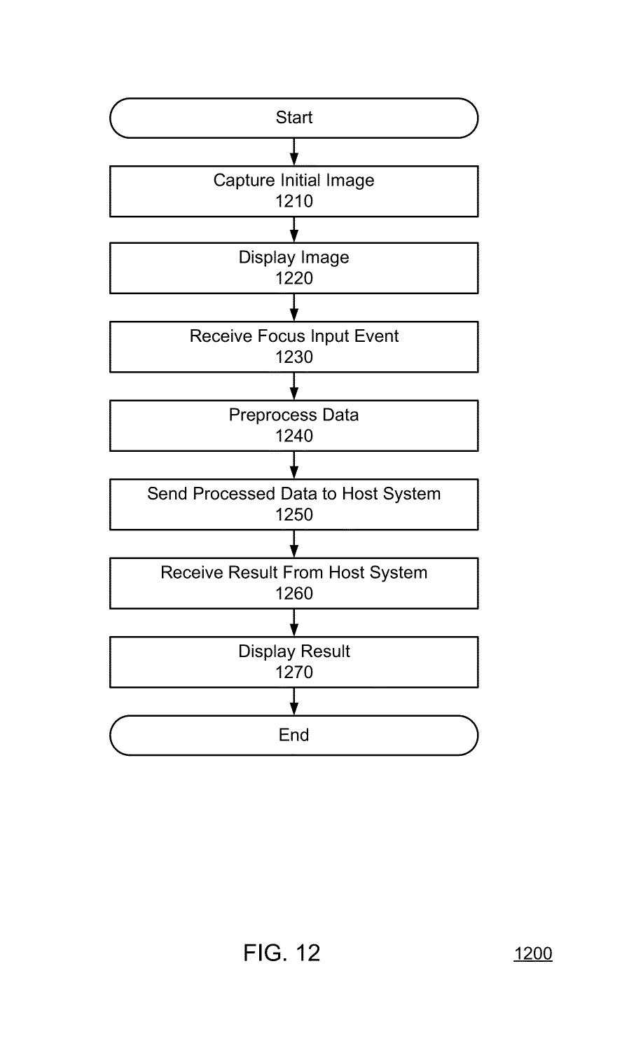

FIG. 12 is a flowchart illustrating one embodiment of a mobile visual commerce system process. In this embodiment, a user device camera and user interface are used to identify products based on photos of those products or similar products. Process 1200 begins when the mobile device captures 1210 an initial image and displays 1220 the captured image to the user through a display device of the user device. The user interface receives 1230 a focus input event which comprises object coordinates within the captured image. For example, the focus input event can be a localization indication such as the coordinates of a tap on the screen of the mobile device. The focus input event and image are compressed and pre-processed 1240 before being sent 1250 to the visual commerce engine where computation is performed on the received data. The mobile device receives 1260 the results of the processing from the host system then displays 1270 the top results to the user.

### Customs Tracking Using Visual Commerce

In one implementation, a visual commerce engine 110 can be utilized to generate appropriate customs classifications for an object based on an image of the object. For example, the visual commerce engine can classify items based on the Harmonized Tariff Schedule of the United States (the tariff schedule used to describe items being imported into the United States).

In some embodiments, the visual commerce engine receives an input image of an object for customs classification from a web server 140 or other connected system. In some configurations, the received image can be an image of the object to be classified in isolation, such as a previously segmented image or studio image of a product, such as an image taken against a plain backdrop. In other configurations, the visual commerce engine 110 receives an image including the object to be classified for customs along with a localization indication. After detecting, categorizing, and describing the object to be classified for customs as described above, the visual commerce engine 110 can compare the object description with other information to determine a correct customs classification. In some embodiments, the visual commerce engine 110 compares the object description with a stored tariff schedule, such as the Harmonized Tariff Schedule, that provides rules for classifying objects based on a type of the object. The visual commerce engine can also compare the object description with object descriptions of objects with a known customs categorization as described earlier, and can categorize the object to be classified based on similarity to these examples. For example, the visual commerce engine 110 can assign the customs classification of the object with the highest similarity. In other embodiments, the visual commerce engine 110 can use a combination of tariff schedule rules and examples with a known customs classification to classify the object for customs. The customs classification of the object can be returned to the requesting web server 140 or sent to another appropriate location, for example, the customs office. In some implementations, the returned information is submitted over a specialized communication channel or in a format specific to a specific customs office, for example, the EDI (Electronic Data Interchange) format used by US customs.

For example, the visual commerce engine 110 can receive a segmented image of pair of shoes along with associated shipment information of a package containing the pictured pair of shoes. The visual commerce engine 110 can detect and describe the pair of shoes as discussed above, and compare the input pair of shoes with other pairs of shoes with known customs classifications. The visual commerce engine 110 can then assign a customs classification to the pair of shoes based on the known customs classifications of shoes determined to be similar, such as by selecting the customs classification of the most similar pair of shoes. In this example, the visual commerce engine 110 then appropriately formats the customs classification along with the other associated shipment information for to send an EDI message for the package, notifying customs of the import of the pair of shoes using the assigned tariff classification.

### Example Visual Commerce System

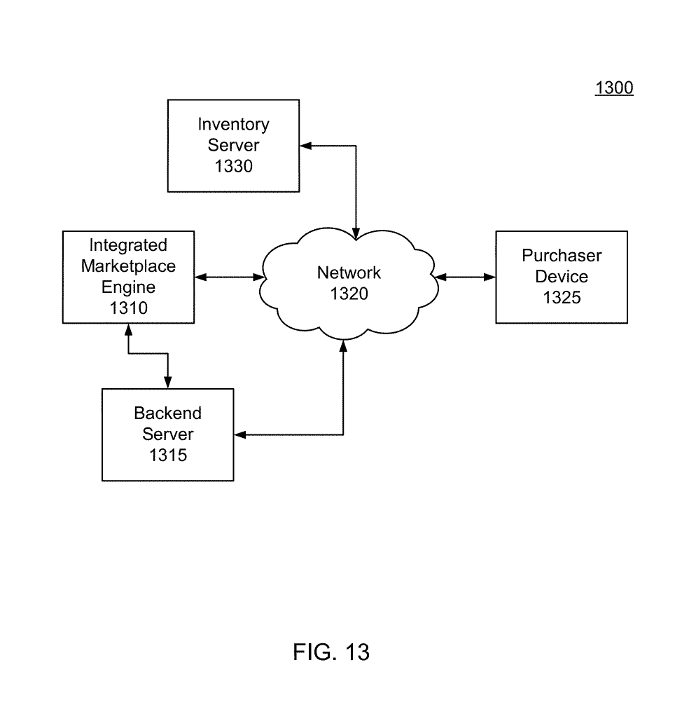

FIG. 13 is a block diagram illustrating an environment in which an example visual commerce engine operates. The environment 1300 includes an integrated marketplace engine 1310, backend server 1315, network 1320, purchaser device 1325, and inventory server 1330. Only one inventory server 1330 and purchaser device 1325 have been shown in FIG. 1, but embodiments can include many inventory servers 1330 and purchaser devices 1325. In this example, the visual commerce engine 1310 operates as part of an integrated marketplace 1300 that allows users of user devices 1325 to purchase and have products shipped to them, for example, from overseas. In some embodiments of an integrated marketplace 1300, products can be described or presented to a user based on an image of the product or a similar product input into the integrated marketplace.

In this embodiment, a purchaser device 1325 is a user device 130 operated by or associated with a user of the integrated marketplace. For example, a purchaser device 1325 can be a smartphone executing an application associated with the integrated marketplace 1300, integrated marketplace engine 1310, or backend server 1315. A purchaser device 1325 can be used to view product images, prices, or other information describing a product or product (hereinafter, “product information”) transmitted by the integrated marketplace engine or the backend server 1315. In some implementations, a purchaser device 1325 requests product information, such as by submitting an object query request to the integrated marketplace engine 1310 requesting product information on products similar to a described product or a product depicted in an input image. The purchaser device 1325 can also receive product information from the integrated marketplace engine 1310 or backend server 1315 automatically, for example, to generate a personalized list of products based on known characteristics of a user associated with the purchaser device 1325. In some embodiments products displayed on the purchaser device 1325 are available for purchase by an operating user from the purchaser device 1325. According to some implementations, a purchaser device 1325 receiving information about a specific product from the integrated marketplace engine 1310 can also receive a list of products similar to the specific product also generated by the integrated marketplace engine 1310.

A network 1320 can comprise any combination of local area and wide area networks and can be wired, wireless, or a combination of wired and wireless networks. For example, a network 1320 can use standard communication protocols, for example hypertext transport protocol (HTTP) or transmission control protocol/Internet protocol (TCP/IP) over technologies such as Ethernet, 4G, or a digital subscriber line (DSL). In some implementations, data transmitted over the network 1320 can be encrypted.

An inventory server 1330 can be a website, application, web-application, database, or other network connected system from which the integrated marketplace engine 1310 can request receive product information. In some configurations, an inventory server 1330 is a server storing information about products available or potentially available for sale within the integrated marketplace. In one implementation, an inventory server 1330 contains product information about products offered for sale by a local vendor or third party from which the integrated marketplace 1300 can purchase. In some embodiments, an inventory server 1330 is connected to the integrated marketplace engine 1310 over a network 1320, but the integrated marketplace engine 1310 and a inventory server 1330 can also be directly connected, such as by a direct Ethernet connection.

In this example, a backend server 1315 is a web server or other network connected system with which coordinates activities of the integrated marketplace engine 1310. In some implementations a backend server coordinates order logistics when a user purchases a product through a purchaser device 1325. This can include ordering the product from a supplier of the product, shipping the product to an address provided by the purchaser device 1325 or stored within a user profile of a user associated with the purchase, and providing tracking information on a shipped package containing the product. In some embodiments, shipped products travel overseas or are shipped internationally; in situations where a shipped product will have to pass through a customs inspection, the backend server 1315 can submit a tariff query request to the integrated marketplace engine 1310 to determine a correct customs classification for the product. In some implementation, a backend server 1315 formats and sends an EDI message to US Customs based on information received from the integrated marketplace engine 1310.

In the embodiment of FIG. 13, an integrated marketplace engine 1310 is a visual commerce engine 110 configured to operate in the integrated marketplace 1300. The integrated marketplace engine 1310 can receive and analyze an image of a product, determine from the image similar or identical products or a tariff classification for the product, and return such information to a backend serer 1315 or purchaser device 1325 as appropriate. For example, integrated marketplace engine can receive queries including images from purchaser devices 1325 and backend servers 1315, as described earlier, and can return relevant information based on similarity with other products or tariff classification rules.

According to some embodiments, the integrated marketing engine 1310 can generate a set of products likely to be of interest to a specific user. In some implementations this set is generated based on photos captured by the user or products interacted with by the user, for example, a product “liked,” viewed, or purchased by the user.

In some implementations, the integrated marketplace engine 1310 can add a new database or set of objects to an object store of the integrated marketplace engine by requesting or receiving data from an inventory server 1330. For example, the integrated marketplace engine 1310 can receive images of products from an inventory server 1330, such as images of products on a web site of the inventory server 1330, and generating the description of each product based on the received images. In some embodiments, the descriptions for the products received from the inventory server are generated by treating the images received from the inventory server as input images to the integrated marketplace engine and analyzing them to generate a description of the product as described above.

### Computing Machine Architecture

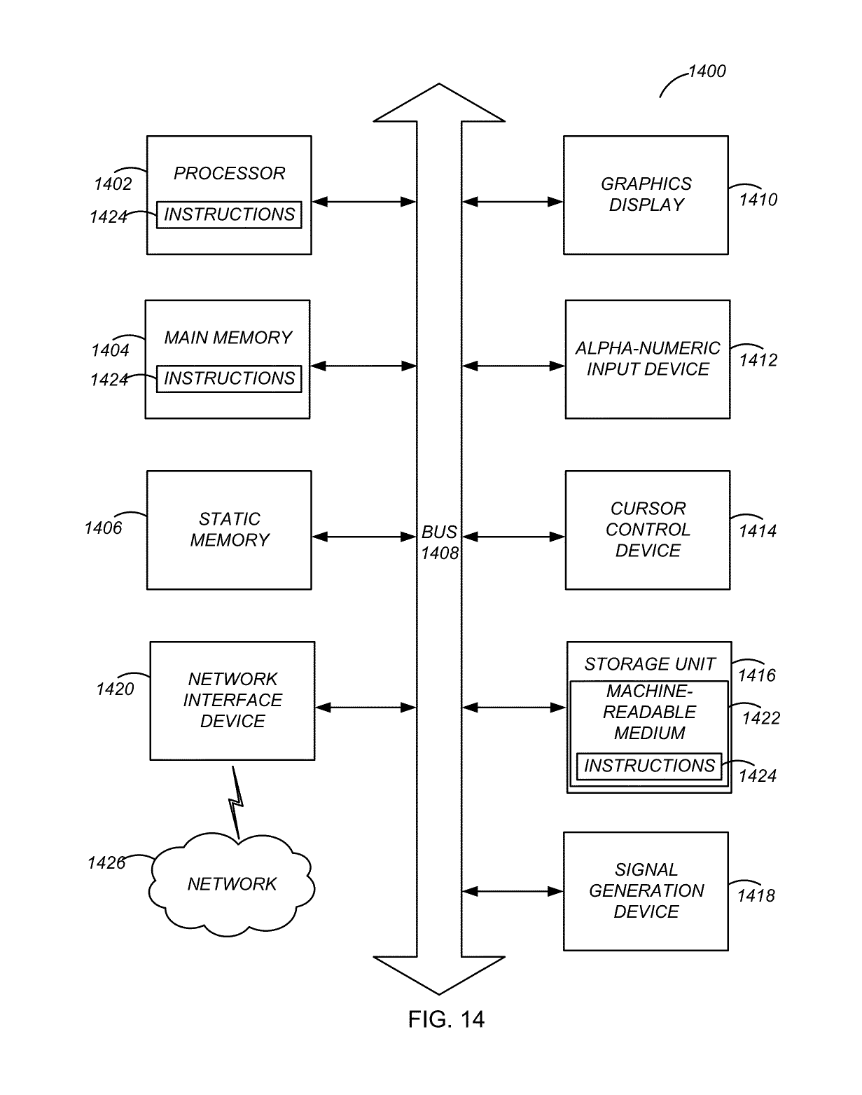

FIG. 14 is a block diagram illustrating components of an example machine able to read instructions from a machine-readable medium and execute them in a processor. Specifically, FIG. 14 shows a diagrammatic representation of a machine in the example form of a computer system 1400 within which instructions 1424 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 1424 (sequential or otherwise) that specify actions to be taken by that machine. Further, while only a single machine is illustrated, the term “machine” shall also be taken to include any collection of machines that individually or jointly execute instructions 1424 to perform any one or more of the methodologies discussed herein.

The example computer system 1400 includes a processor 1402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 1404, and a static memory 1406, which are configured to communicate with each other via a bus 1408. The computer system 1400 may further include graphics display unit 1410 (e.g., a plasma display panel (PDP), a liquid crystal display (LCD), a projector, or a cathode ray tube (CRT)). The computer system 1400 may also include alphanumeric input device 1412 (e.g., a keyboard), a cursor control device 1414 (e.g., a mouse, a trackball, a joystick, a motion sensor, or other pointing instrument), a storage unit 1416, a signal generation device 1418 (e.g., a speaker), and a network interface device 1420, which also are configured to communicate via the bus 1408.

The storage unit 1416 includes a machine-readable medium 1422 on which is stored instructions 1424 (e.g., software) embodying any one or more of the methodologies or functions described herein. The instructions 1424 (e.g., software) may also reside, completely or at least partially, within the main memory 1404 or within the processor 1402 (e.g., within a processor's cache memory) during execution thereof by the computer system 1400, the main memory 1404 and the processor 1402 also constituting machine-readable media. The instructions 1424 (e.g., software) may be transmitted or received over a network 1426 via the network interface device 1420.

While machine-readable medium 1422 is shown in an example embodiment to be a single medium, the term “machine-readable medium” should be taken to include a single medium or multiple media (e.g., a centralized or distributed database, or associated caches and servers) able to store instructions (e.g., instructions 1424). The term “machine-readable medium” shall also be taken to include any medium that is capable of storing instructions (e.g., instructions 1424) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

The disclosed configurations include advantages such as efficient classification, description, and comparison of objects based on data extracted from images of the objects. In some example implementations, the disclosed configuration beneficially allows a user to input an object into the system for comparison by capturing a photo of the object on a user device. Also by way of example, the disclosed configuration beneficially allows for description or classification of an object based on already existing images associated with the object, for example in tariff calculation implementations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated in FIGS. 1-7. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods, e.g., as shown in FIGS. 6a, 6b, 8-10, and 12, described herein may be performed, at least partially, by one or more processors, e.g., processor 1402, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for a visual commerce engine to identify objects based on an image including the object and, based on a description of the identified object, determine other associated objects through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method to provide information related to a product based on an image of the product, the method comprising:
receiving, at a visual commerce engine from a user device, an image of a product;
receiving, at the visual commerce engine from a user device, a localization indication indicating a location within the image associated with the product;
analyzing, by a processor, the image to determine a set of potential products depicted in the image, each potential product associated with a region of the input image;
selecting, from the set of potential products, a detected product based on the localization indication and the associated region of each potential product of the set of potential products;
determining a description of the detected product based on the associated region of the image; and
comparing the description of the detected product with a library of products to determine a set of similar products from the library of products.

2. The method of claim 1, further comprising:
determining purchase information about each product of the set of similar products; and
transmitting, from the visual commerce engine, the determined purchase information to the user device.

3. The method of claim 1, wherein a potential product is a segmented version of the image and wherein analyzing the image to determine a set of potential products comprises segmenting the image using a plurality of conditional random field models to generate a plurality of segmented images.

4. The method of claim 1, wherein determining a description of the detected product further comprises analyzing the detected product using a convolutional neural network.

5. A method comprising:
receiving, at a visual commerce engine, an image of an object;
receiving, at a visual commerce engine, a localization indication indicating the location of the object within the image;
analyzing the image to determine a set of potential objects present in the image;
selecting, from the set of potential objects in the image, an object of interest based on the localization indication; and
comparing the object of interest with a library of objects to determine a set of objects similar to the object of interest.

6. The method of claim 5, wherein selecting an object of interest comprises segmenting and cropping the image to isolate the object of interest from background features of the image.

7. The method of claim 5, wherein comparing the object of interest with a library of objects comprises using a convolutional neural network to generate a feature vector for the image.

8. The method of claim 7, wherein comparing the object of interest with a library of objects further comprises comparing the feature vector for the image with feature vectors associated with objects of the library of objects.

9. The method of claim 5, wherein analyzing the image to determine a set of potential objects comprises segmenting the image using a plurality of conditional random field models to generate a plurality of segmented images.

10. The method of claim 5, further comprising determining a customs classification for the object based on customs classifications associated with objects of the set of objects similar to the object of interest.

11. The method of claim 5, wherein the image of the object is captured by a camera of a user device.

12. A system for obtaining a customs classification of an object, the system comprising:
an interface module configured to receive an image of an object and transmit a customs classification of the object;
an object analysis module the image configured to determine an object of interest present in the image;
a comparison module configured to compare the object of interest with a library of objects to determine a set of objects similar to the object of interest, each object of the set of objects similar to the object of interest associated with a customs classification; and
a customs classification module configured to determine a customs classification of the object based on the customs classification of the objects in the set of objects similar to the object of interest.

13. The system of claim 12, wherein the interface module is further configured to transmit a message including the customs classification of the object of interest to a customs office.

14. The system of claim 13, wherein the transmitted message including the customs classification of the object of interest is in an EDI format.

15. The system of claim 12, wherein the comparison module is further configured to segment the image using a plurality of conditional random field models to generate a plurality of segmented images.

16. The system of claim 12, wherein the comparison module is further configured to utilize a convolutional neural network to generate a feature vector for the object of interest.

17. The system of claim 12, wherein determining a customs classification of the object further comprises comparing features the object of interest with a tariff schedule.

18. A computer program product comprising a non-transitory computer readable medium containing instructions that, when executed by a processor cause the processor to perform the steps of:
receiving, at a visual commerce engine, an image of an object;
receiving, at a visual commerce engine, a localization indication indicating the location of the object within the image;
analyzing the image to determine a set of potential objects present in the image;
selecting, from the set of potential objects in the image, an object of interest based on the localization indication; and
comparing the object of interest with a library of objects to determine a set of objects similar to the object of interest.

19. The computer program product of claim 18, wherein selecting an object of interest comprises segmenting and cropping the image to isolate the object of interest from background features of the image.

20. The computer program product of claim 18, wherein comparing the object of interest with a library of objects comprises using a convolutional neural network to generate a feature vector for the image.

21. The computer program product of claim 20, wherein comparing the object of interest with a library of objects further comprises comparing the feature vector for the image with feature vectors associated with objects of the library of objects.

22. The computer program product of claim 18, wherein analyzing the image to determine a set of potential objects comprises segmenting the image using a plurality of conditional random field models to generate a plurality of segmented images.

23. The computer program product of claim 18, further comprising determining a customs classification for the object based on customs classifications associated with objects of the set of objects similar to the object of interest.

24. The computer program product of claim 18, wherein the image of the object is captured by a camera of a user device.

25. A computer program product comprising a non-transitory computer readable medium containing instructions that, when executed by a processor cause the processor to perform the steps of:
displaying, on a user device, an image of a product;
receiving, at the user device from an operator of the user device, an identification of the location of the product within the image;
transmitting, from the user device to a visual commerce engine, the image and localization indication;
receiving, from the visual commerce engine at the user device, information about a set of results products similar to the product; and
presenting the received information to an operator of the user device.
